(19) United States
(12) Patent Application Publication
(10) Pub. No.: US 2010/0111689 A1
(43) Pub. Date: May 6, 2010

(54) ULTIMATE WIND TURBINE SYSTEM METHOD AND APPARATUS

(76) Inventor: Edward L. Davis, Portland, OR (US)

Correspondence Address: Cionca Law Group P.C., 333 City Blvd W, Ste 1700, Orange, CA, 92868, US

(21) Appl. No.: 12/573,857

(22) Filed: Oct. 5, 2009

Related U.S. Application Data
(60) Provisional application No. 61/103,086, filed on Oct. 6, 2008.

(51) Int. Cl. F03D 3/04

(52) U.S. Cl. 415/229

(57) ABSTRACT

An Ultimate Wind Turbine Energy Generator that will start moving and generating energy at very low wind speeds (i.e. very slight motion or torque), that has magnetic bearings with near zero friction which support the Generator and Wind turbine apparatus without consuming external energy to control them.

### CROSS-REFERENCE TO RELATED APPLICATIONS

This application claims priority from U.S. Provisional Patent Application 61/103,086, titled, Power Generation” filed on Oct. 6, 2008 the entire disclosure of which is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

Embodiments of the present invention relate generally to Energy Generation.

2. Description of the Related Art

Conventional Wind Turbines are predominantly of the horizontal axis wind turbine (HAWT) or vertical axis wind turbine (VAWT) types. And there are basically two types of VAWT's, the Darrieus type is based on an airfoil (like an airplane wing) and it is capable of rotating with a tip speed faster than the windspeed. The Savonius type (like an anemometer) is capable of rotating with a tip speed less than or equal to the windspeed.

The Savonius type is capable of starting up at fairly low wind speeds. That's why anemometers can measure fairly slight windspeeds. They may also measure significant windspeeds all the way up to hurricane force winds.

The Darrieus type has a tougher time starting up. It requires a higher windspeed to get it started (similar to how an airplane needs to go at a fairly high speed in order to lift-off).

There is also a need for magnetic bearings with near zero friction that support the Generator and Wind turbine apparatus without consuming external energy to control them.

There is a need for a wind turbine that will start moving at very low wind speeds.

There is a need for a generator which will generate power even with very slight motion or torque.

There is a need for a wind turbine/generator coupled together that generates power even in very low wind speeds. The instant invention accomplishes all these goals.

### BRIEF SUMMARY OF THE INVENTION

It is an object of the present invention to provide a highly integrated Wind Turbine and Wind Energy Power Generation System, method and apparatus which has the capability to generate energy anytime 24/7/365 even if the wind only blows a gentle (<5 knot) breeze.

Another object of the present invention is to provide contact-less magnetic bearings with near zero friction that support the Generator and Wind turbine apparatus without consuming external energy to control them.

### BRIEF DESCRIPTION OF THE DRAWINGS

The present invention may be better understood, and its numerous objects, features, and advantages made apparent to those skilled in the art by referencing the accompanying drawings.

FIG. 1 is a prior art image of an existing Darrieus type VAWT

FIG. 2 is a prior art image of an existing Savonius type VAWT

FIG. 3 is a prior art image of an alternator/generator

FIG. 4 illustrates a prior art image of a magnetic bearing.

FIG. 5 illustrates the LSG Wind Turbine, Darrieus Type

FIG. 6 illustrates the LSG Wind Turbine, Savonius Type.

FIG. 7 illustrates the ULTIMATE Wind Turbine, Darrieus-Savonius Hybrid Type

FIG. 8 illustrates the Ultimate Wind Turbine Drive Train Assembly which shows the Ultimate Wind Turbine Assembly mounted on top of the iMAG Generator Assembly with the Magnetic “Floating” bearings.

FIG. 9 illustrates the Inverse Magnetic Alternator Generator Perspective View

FIG. 10 illustrates the Ultimate Wind Turbine Savonius type (Drag) Rotor Element with close-up of blades

FIG. 11 illustrates the Contact-less Magnetic Bearings for IMAG Embodiment #1

FIG. 12 illustrates the Cylindrical Halbach Array Contact-less Magnetic Bearing Embodiment #2

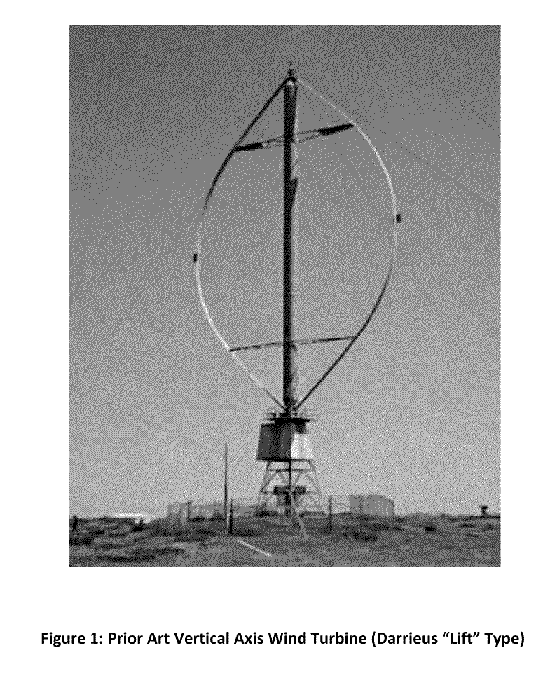

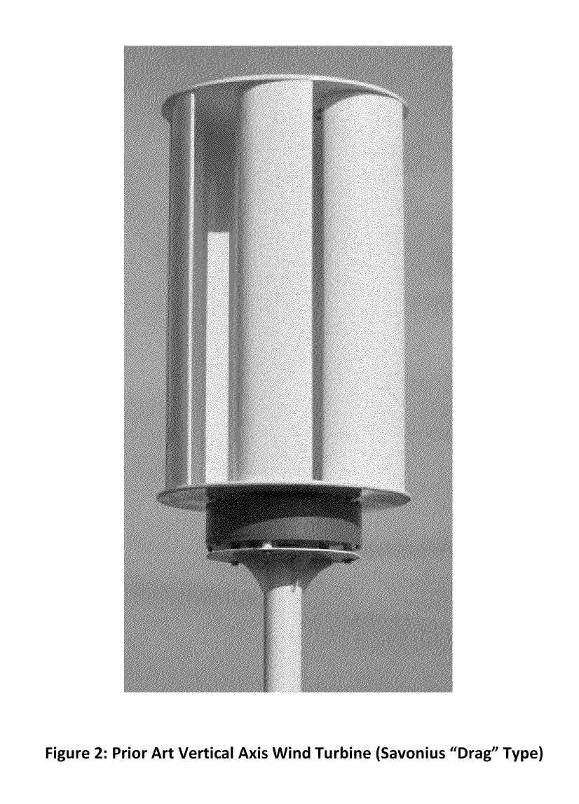

### DETAILED DESCRIPTION OF THE INVENTION

The following sets forth a detailed description of a mode for carrying out the invention. The description is intended to be illustrative of the invention and should not be taken to be limiting.

The following described embodiments relate to power generation using various power generators and/or turbines. The Ultimate Wind Turbine including the composite Darrieus/Savonius type VAWT and a magneto alternator generator (MAG) the precursors of which are described in detail in U.S. Provisional Application No. 61/103,086 titled “Power Generation” filed on Oct. 6, 2008, the entire disclosure of which is hereby incorporated by reference.

The Ultimate Wind Turbine is organized as four major subassemblies, 1) the housing, which may be a cupola form factor, 2) the wind turbine blade and rotor assembly, 3) The Generator assembly which includes rotor, stator, coils, etc. and 4) The magnetic bearing and support assembly

The housing for the Ultimate Wind Turbine in this embodiment is a cupola form factor, which may be constructed of various woods, plastics, metals or combinations. In this embodiment there is a very coarse mesh screen around the cupola to prevent birds from getting caught in the turbine.

The two main types of VAWT's, Darrieus (lift based) or Savonius (drag based) turbines. The Darrieus type is known to be capable of rotor tip speeds faster than the wind speed, whereas, the Savonius type is capable of tip speeds less than or equal to the wind speed. The Darrieus type is known to be capable of rotor tip speeds faster than the wind speed, whereas, the Savonius type is capable of tip speeds less than or equal to the wind speed.

One problem with a Darrieus type VAWT is its inability to self-start.

Embodiments of the present disclosure include a novel hybrid Darrieus/Savonius VAWT that uses the shorter radius Savonius blades to self-start and the longer radius double helix shaped Darrieus wings to take off and generate more power at higher windspeeds.

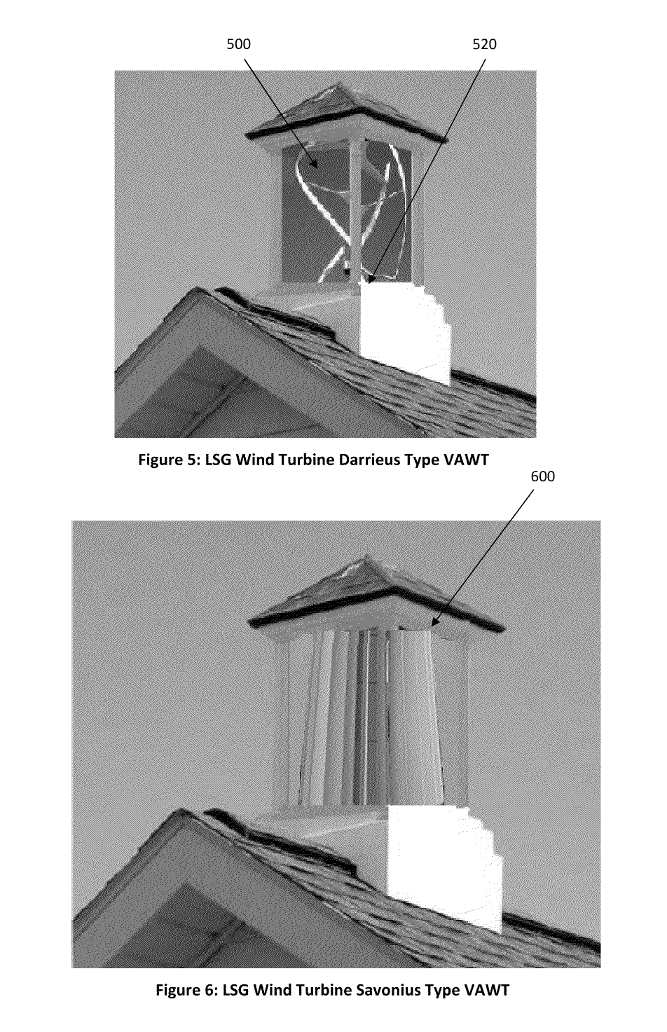

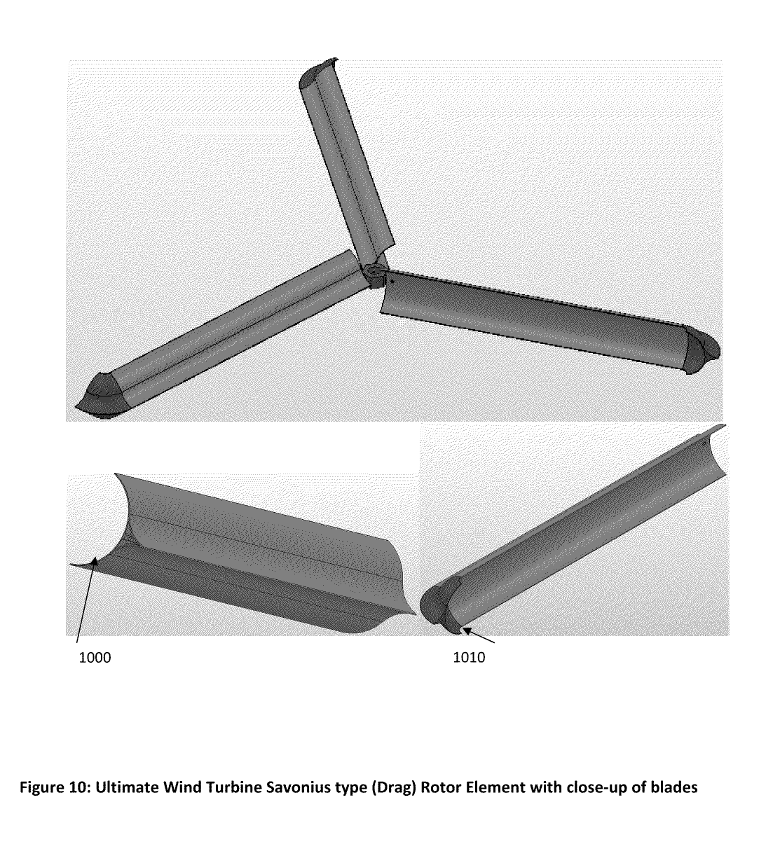

The wind turbine blade and rotor assembly are illustrated in FIGS. 5,6 and 7 with various views of a cupola installation of some embodiments. The inner Savonius style blades FIG. 10 may include a closed end 1010 and an open end 1000. The closed end 1010 may have a cupped portion 1010 (shown attached in FIG. 10) to catch the propelling medium early in a revolution cycle on a leading edge and tapered like an airfoil, or formed into a modified aerodynamic “V” shape, on the trailing edge to reduce resistance from the propelling medium as it comes around.

FIG. 10 illustrates a single three blade rotor assembly in accordance with some embodiments. There may be four or more blades with one or more rotors per LSG turbine. The spinning assembly may be mounted horizontally with the blade length parallel to the earth for wind or ocean.

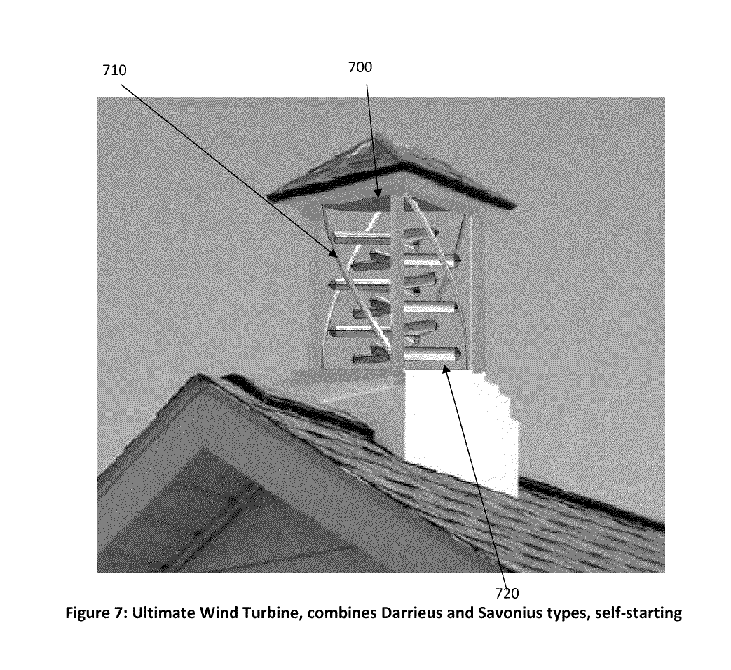

FIG. 7 illustrates a basic, 2 KW working prototype of Ultimate Wind Turbine in accordance with some embodiments. The LSG turbine in this embodiment is a Darrieus-Savonius type turbine, also called the, “Ultimate Wind Turbine”.

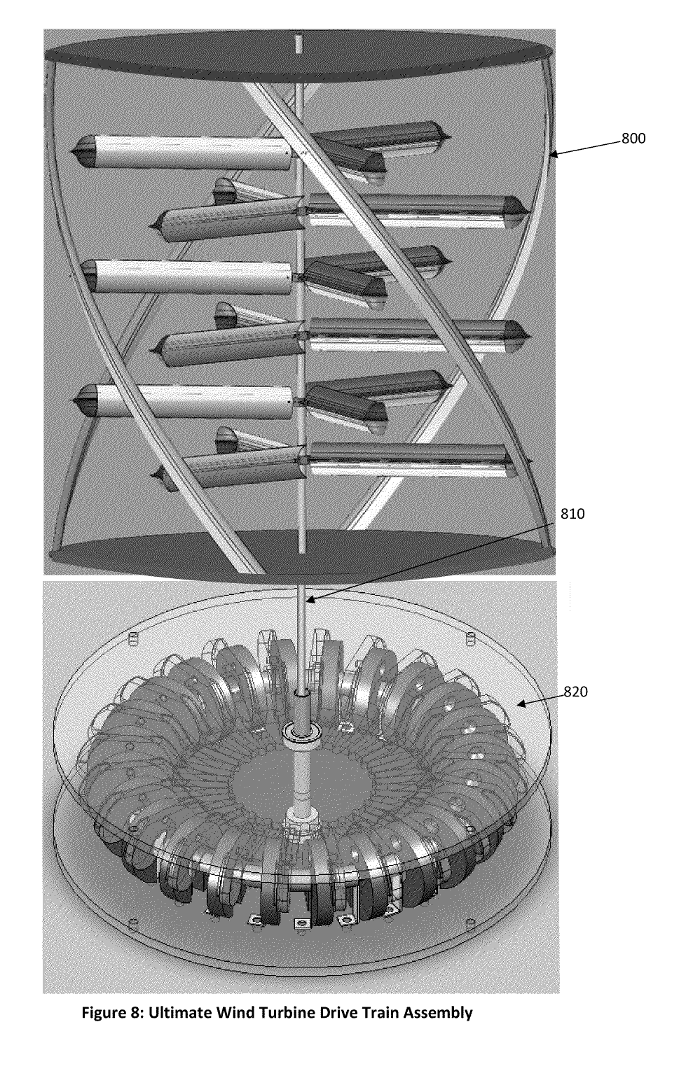

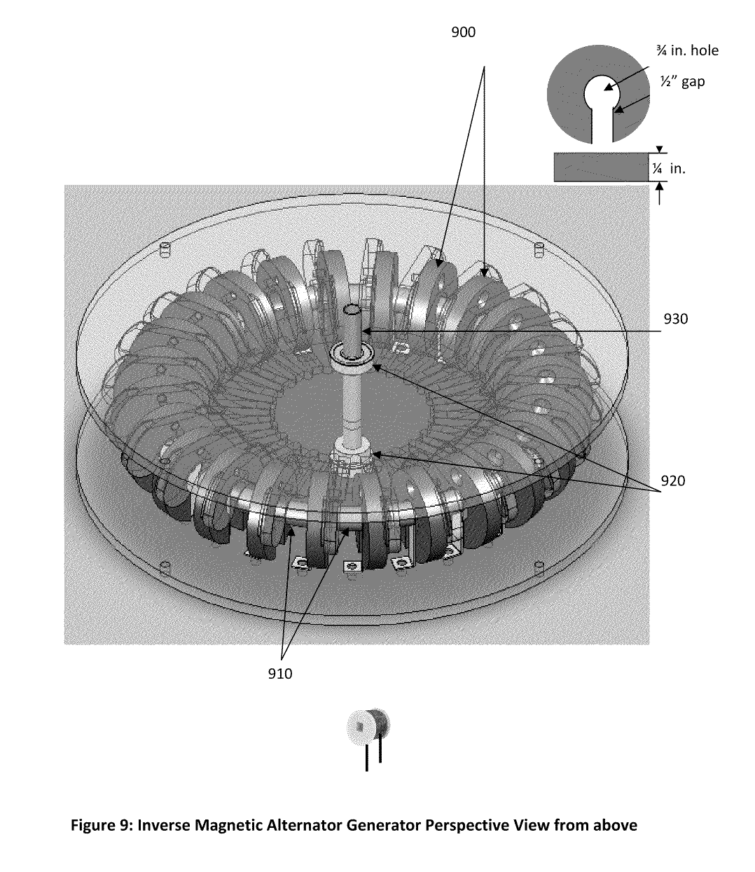

The Ultimate Wind Turbine LSG Turbine FIG. 8 may include a high efficiency, inverse magneto alternator generator (iMAG). In some embodiments, the iMAG FIG. 9 may be approximately 99% efficient and may still generate power at very low wind speeds, e.g., less than 1 knot. Embodiments of the iMAG FIG. 9 are described in further detail below. The tip speed ratio (TSR) of the Savonius type LSG turbine FIG. 6 may always be less than or equal to the wind speed.

The Savonius type LSG turbine 400, with its relatively low TSR, may benefit from the iMAG FIG. 9 generating power at very low wind speeds.

The Savonius type LSG Turbine FIG. 6 may have cupped portions 1010 on the end of each of the blades.

FIG. 5 illustrates a Darrieus type LSG turbine 500 in accordance with some embodiments. This Darrieus type LSG turbine 500 is a three blade design with a single rotor. Various embodiments may include more blades and/or rotors to distribute the load. The TSR of the Darrieus type LSG turbine 500 may be much greater than one, but it still may benefit from a MAG that generates power at very low wind speeds as it spins up or slows down.

FIG. 7 illustrates an Ultimate Wind Turbine LSG turbine 700 mounted in a cupola 700 on a rooftop. Unlike traditional rooftop wind turbines, the Ultimate Wind Turbine LSG turbine 700, is a Darrieus-Savonius type turbine and it does not need to be elevated 50 feet to 100 feet above the roof, because energy is generated even very near zero wind speed. Furthermore, the slope of a roof may actually help to gather more wind in many cases acting like a scoop.

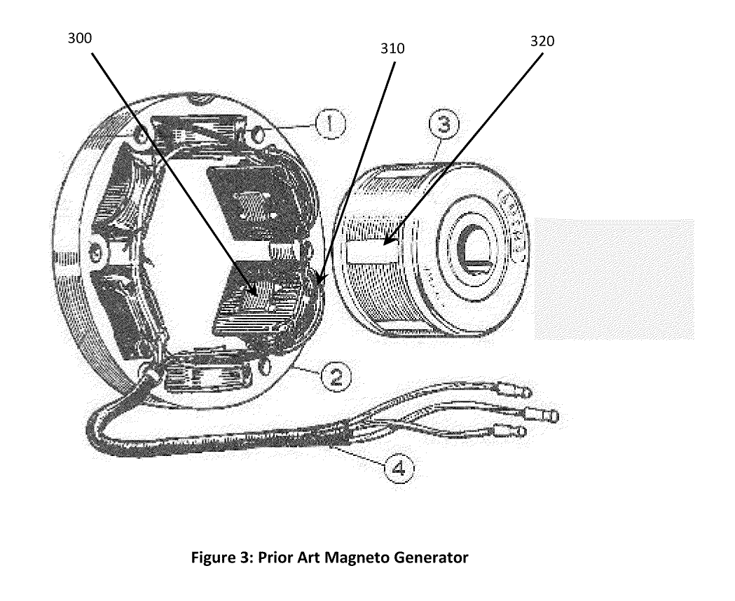

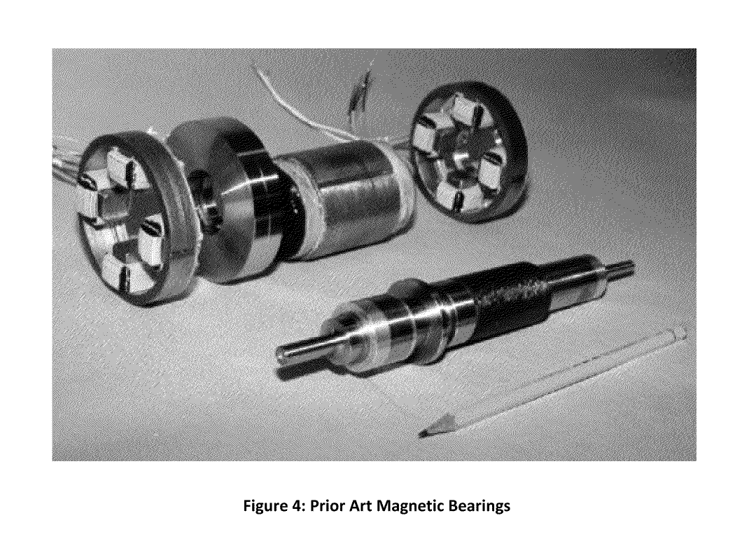

FIG. 3 illustrates a prior art alternator 300 (or generator) that converts mechanical energy into electrical energy. As is shown, a prior art alternator includes rotors and stators where a multiplicity of coils are arranged radially in the stator and a rotor rotates around this stator either on the inner diameter (ID) or the outer diameter (OD) of the stator.

The rotor has a multiplicity of permanent magnets embedded in its periphery. As the rotor rotates, each magnet is brought in close proximity to the base of each ferromagnetic core that each coil is wrapped around. The magnetic field of the permanent magnet is temporarily imposed on the ferromagnetic core of each coil. This creates a current in the coil which is extracted to use for electrical energy.

One of the problems is the energy lost by the attraction of the rotor magnets to the stator cores as the rotor is turned. If the rotor is turned slowly by hand, these “detent” positions can be felt very pronounced. The rotor tends to almost lock at each detent position. It takes quite an amount of inertial energy to overcome these detent positions in order to get the rotor spinning. The more coils, the more magnets the bigger the device, the stronger these detent positions are. This wastes useful energy rendering the generator or alternator much less efficient.

FIG. 9 illustrates the iMAG FIG. 9 in accordance with some embodiments. The iMAG shown in FIG. 9 includes a rotor 900 which has rotor magnets (Typically 24 or 48) on the outer edge of the arm equally spaced around the periphery. These NdFeB or similar magnets in the preferred embodiment are 2 inch O.D and ¾ inch I.D. and ¼ inch thick with a ½ inch wide slot cut to allow it to pass over the mounting base for the ½ inch coils 910. There are typically 24 to 48 coils mounted on the bottom stator plate and the rotor magnets simply pass over these coils to generate electricity. The coils have a non-ferro magnetic core, so there is no force lost by a detent position such as conventional generators have. The magnets in the rotor have one N face on the flat side and a S face on the opposite side. The rotor magnets may be mounted alternating, N, S, N, S, . . . so that as one rotor magnet passes over a coil it creates a “back magnetic field” and temporarily “magnetizes it” so to speak in one direction, that it will attract the next magnet in sequence and thereby magnify the energy output of the generator.

The electricity generated in each coil increases with each loop of wire that is added to the coil and also with the diameter of the coil(s). The coils 910 in this preferred embodiment are limited to ½ inch diameter in order to fit inside the ¾ inch bore of the rotor magnets as they rotate past. The stator housing in the preferred embodiment is ten inches diameter, but it could be much larger (or smaller). The rotor magnets each weigh about 0.1 Kg and having a one Tesla B field. Each coil 910 may include 100 turns or more of 24 to 28 AWG magnet wire. The specifics of this particular embodiment are merely to facilitate disclosure and do not restrict other embodiments.

The stator assembly may be evacuated to provide a vacuum that offers little resistance to the spinning rotor magnets 900.

This model of an iMAG is scalable up to hundreds of kilowatts. For a Savonius type wind turbine which has high torque, low speed, one may make a large diameter generator so that the tip speed is increased. For a Darrieus type wind turbine or any HAWT, that has a TSR greater than one, it may be okay to use a smaller diameter. For regenerative breaking in an automobile or other vehicle, many diameters would work.

As each pair of the rotor magnets passes by one of the coils, it produces two pulses approximately two volts peak to peak in amplitude in a 1 to 2 knot wind. Conventional generators won't even start up at this speed. The iMAG 900 generates power all the way down to near zero.

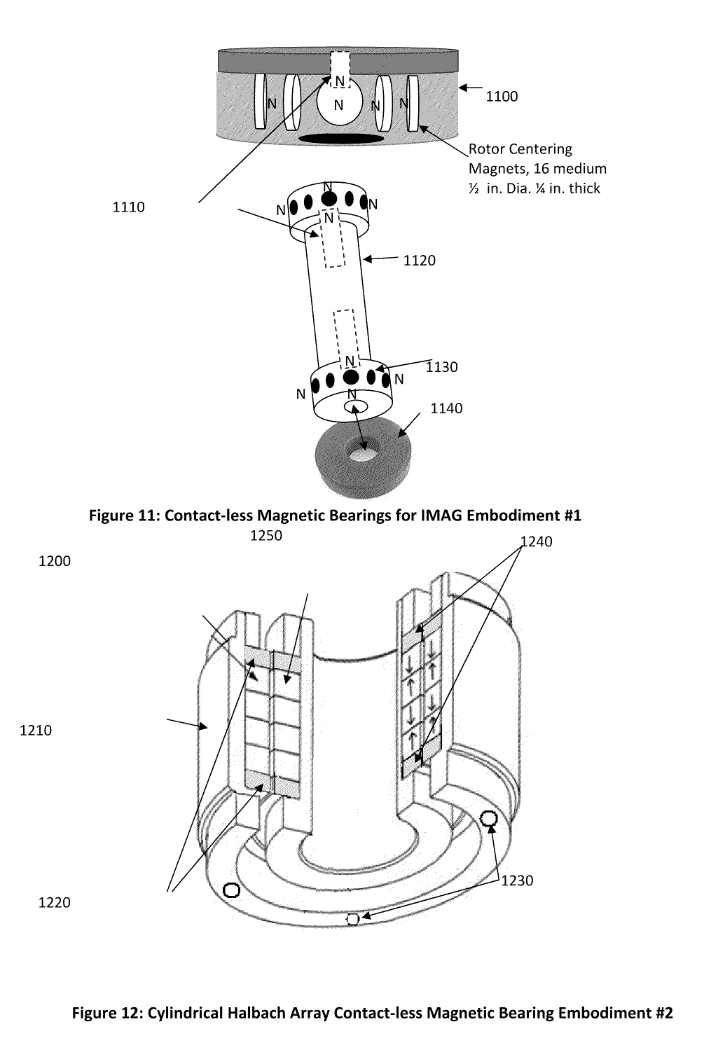

The magnetic bearings require no electrical current to control them. FIGS. 11 and 12 Illustrate two embodiments to accomplish this. FIG. 11 uses repulsion all the way around to support rotating motion.

The embodiment in FIG. 11 uses tiny NdFeM magnets embedded in the bearing races and housings that repel each other to maintain the shaft suspended in equilibrium.

The embodiment in FIG. 12 uses a cylindrical Halbach array (four smaller ring magnets for the rotor and four larger ring magnets for the stator. In both cases the flat faces are the N and S poles. They are arranged like a classic halfback array, ie. Opposing each other. The arrows in FIG. 12 show the N poles are repelling and the S poles are repelling in the four ring set.

Both FIG. 11 and FIG. 12 use ring magnets embedded in the support platform coupled with cylindrical magnets embedded in the end of the shaft to eliminate translational (up and down) motion.

The Cylindrical Halbach Array embodiment in FIG. 12 has a shaft threaded at each end. One of the aluminum jam nuts is placed on the shaft, then the four magnets are arranged and the other aluminum jam nut compresses the magnets together.

Similarly for the stator magnets, a short thick piece of T-6 Aluminum tubing 3″ diameter houses the 2″ ring magnets. The tube is tapped for a 2″×24 threads per inch insert. The retainer insert is placed in, then the magnets then the other jam insert is used to press the array together.

Other embodiments have also been disclosed and described.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. An Ultimate Wind Turbine apparatus comprising means for starting up and/or generating power at very low windspeeds even down to 5 knots or less which may be installed in a cupola or other form factors.

2. A generator capable of generating energy at very low revolutions per minute (RPM). In some cases down to one RPM or less.

3. Magnetic suspension bearings that can support a wind turbine and/or alternator/generator assembly with very little friction wherein the rotating shaft does not make contact with the stator in normal operating mode.

4. The permanent magnets in claim 3 consisting of Samarium Cobalt (SmCo), Aluminum Nickel Cobalt (AlNiCo) Neodymium Iron Boron (NdFeB) or any other magnetic material with a working temperature above 200 degrees and a Curie temperature above 300 degrees C.

5. The Magnetic suspension bearings in claim 3 that include a ring magnet that pushes upward on the shaft against a cylindrical magnet embedded in the end of the shaft, or downward from the top.
